(19) United States
(12) Patent Application Publication
(10) Pub. No.: US 2005/0183915 A1
(43) Pub. Date: Aug. 25, 2005

(54) Device for accommodating wire storage structure

(76) Inventor: Jose Wei, Hsin Tien City (TW)

Correspondence Address: Jose WEI, P.O. Box No. 6-57, Taipei, 235, TW

(21) Appl. No.: 10/890,167

(22) Filed: Jul. 14, 2004

(30) Foreign Application Priority Data
Feb. 20, 2004 (TW) 093104382

(51) Int. Cl. H02G 11/00

(52) U.S. Cl. 191/12 R

(57) ABSTRACT

A device for accommodating a wire storage structure includes a wire storage device consisted of left and right housing, a main wheel and an axis portion, a continuous signal wire stored at A and B wire storage breadths, and a seat. When the wire storage has wires thereof collected and stored, an overall structure of the wire storage structure is stored in a fixed seat and is prevented from being exposed to an exterior when not in use. Thus, when an upper wire is pulled out when a user's hand tugs an earphone microphone, the main body of the wire storage structure is kept away from inappropriate handling as well as damages caused by external forces.

### BACKGROUND OF THE INVENTION

(a) Field of the Invention

The invention relates to a device for accommodating a wire storage structure, and more particularly, to a device having housing with a chamber for accommodating a wire storage structure therein, thereby positioning and keeping the wire storage structure unexposed as well as preventing the wire storage structure from damages caused by external forces.

(b) Description of the Prior Art

According to a prototypic prior communication wire storage structure disclosed by Taiwan Patent Publication No. 539321, Hand-free Handset Wire Winding Box, a same signal wire defined as upper and lower wires is winded around a uniform diameter turning wheel. When an earphone wire is withdrawn, the main wheel is rotated relative to an axis portion as a rotation axis thereof, such that a length of the earphone wire released is equal to that of a lower terminal plug wire. Thus, when the earphone wire is released, the entire wire storage structure is relatively displaced between the upper and lower wires. However, the aforesaid structure has following drawbacks when put to long-term use:

1. Due to frequent inappropriate operation by users pulling the entire wire storage structure outward, the lower wire is set out while the upper wire remains unreleased, with the main wheel continuing to rotate. Consequently, the upper wire is disorderly congested within a wire storage chamber at the main wheel to further result in jamming of the wire. Especially when users are to resolve the aforesaid situation, the upper wire remained unreleased is often directly pulled out, leading to knotting of the upper wire. In addition, wire or wire storage structure are prone to damages caused by pulling and dragging using excessive forces.

2. When idle, the wire storage structure is exposed to human bodies with wires thereof unprotected, and therefore damages are likely formed owing to squeezing and contact with hard objects; for instance, when placed in a wallet.

3. When the wire storage structure is applied between an electric appliance (such as a computer host, a mouse or a battery charger) and a power supply, or between electric appliances (such as computer hosts), when the upper and lower wires are collected into the wire storage structure as an idle state, similar drawbacks as the abovementioned are incurred as the entire wire storage structure is exposed to an exterior to lead to accumulation of dust and dirt.

### SUMMARY OF THE INVENTION

The primary object of the invention is to provide a device for accommodating a wire storage structure that is accommodated in a chamber of a fixed seat, such that an upper wire is pulled and released without inappropriately tugging a wire storage structure main body, thereby preventing mishandling the wire storage structure main body as well as damages of the wire storage structure from being compressed by external forces.

The other object of the invention is to provide a device for accommodating a wire storage structure that is accommodated in a chamber of a fixed seat when wires thereof are collected and stored, such that accumulation of dust and dirt is avoided by keeping the wire storage structure unexposed to an exterior.

Referring to FIGS. 1-3, the device according to the invention comprises of:
a wire storage structure 10 consisted of left and right housings 12 and 16, a main wheel 20 and an axis portion 15;
the main wheel 20 capable of elastic rotations relative to the axis portion 15 as a rotation axis thereof, and having at least two A and B wire storage breadths 22 and 23;
a continuous signal wire 30 having a fixed section 31 wedged and fastened at a position between the A and B wire storage breadths 22 and 23, and winded around the A and B wire storage breadths 22 and 23 in opposite directions to define upper and lower wires 33 and 36; and
a seat 50 having an accommodating chamber 52, which is provided with an opening 54 for inserting through the lower wire 36, with the wire storage structure 10 displaced into the accommodating chamber 52 and positioned therein when the upper and lower wires 33 and 36 are collected and stored at the A and B wheel breadths 22 and 23.

According to the aforesaid primary characteristics, wherein an outer diameter D of the A wire storage breadth 22 is larger than an outer diameter d of the B wire storage breadth 23.

According to the aforesaid primary characteristics, wherein the outer diameter D of the A wire storage breadth 22 is equal to the outer diameter d of the B wire storage breadth 23.

According to the aforesaid primary characteristics, wherein the outer diameter D of the A wire storage breadth 22 is smaller than the outer diameter d of the B wire storage breadth 23.

According to the aforesaid primary characteristics, wherein the seat 50 is directly devised at an exit of a mouse 75, a fixed end 362 of the lower wire 36 is electrically connected to an internal structure of the mouse 75 in a direct manner, and an outer end of the upper wire 33 is connected to a plug 335 (a socket 335), thereby storing the wire storage structure 10 into the accommodating chamber 52 as shown in FIG. 8.

According to the aforesaid primary characteristics, wherein the seat 50 is directly devised at an interior or at an outer periphery of a battery charger 85, whereas an opening of the accommodating chamber 52 is disposed at an end portion of the battery charger 85. The fixed end 362 of the lower wire 36 is fastened to a hardware structure at the interior of the mouse 75. The upper wire 33 is connected externally to the plug 335 and the wire storage structure 10 is reversely displaced back into the accommodating chamber 52 for protection (as shown in FIG. 9).

According to the aforesaid primary characteristics, a fastening member 37 is utilized to fasten at a suitable section of the lower wire 36 and in the opening 54, such that the lower wire 36 is formed with a fixed end 361.

According to the aforesaid primary characteristics, wherein a rear wall of the seat 50 is provided with an elastic clamp 58 for clamping to clothing 70 as shown in FIGS. 2-4.

According to the aforesaid primary characteristics, wherein the outer end of the upper wire 33 is connected to an earphone microphone 60 (or an earphone), and an outer end of the lower wire 36 is connected to a terminal plug (or a socket) 62 as shown in FIGS. 1-3.

According to the aforesaid primary characteristics, wherein the outer ends of the upper and lower wires 33 and 36 are respectively connected to Universal Serial Bus (USB) connectors 66 as shown in FIGS. 5 and 6.

According to the aforesaid primary characteristics, wherein a side groove 21 at an interior of the main wheel 20 is connected to a spring 80, which has an inner end thereof joined and fixed to the axis portion 15, so as to allow the main wheel 20 to form as an elastic element as shown in FIGS. 2 and 3.

According to the aforesaid primary characteristics, wherein a side of the seat 50 is connected to an accommodating rope 19 to be placed around a neck as shown in FIG. 7.

### BRIEF DESCRIPTION OF THE DRAWINGS

FIG. 1 shows an elevational view illustrating the invention implemented to a cellular phone and with a wire released.

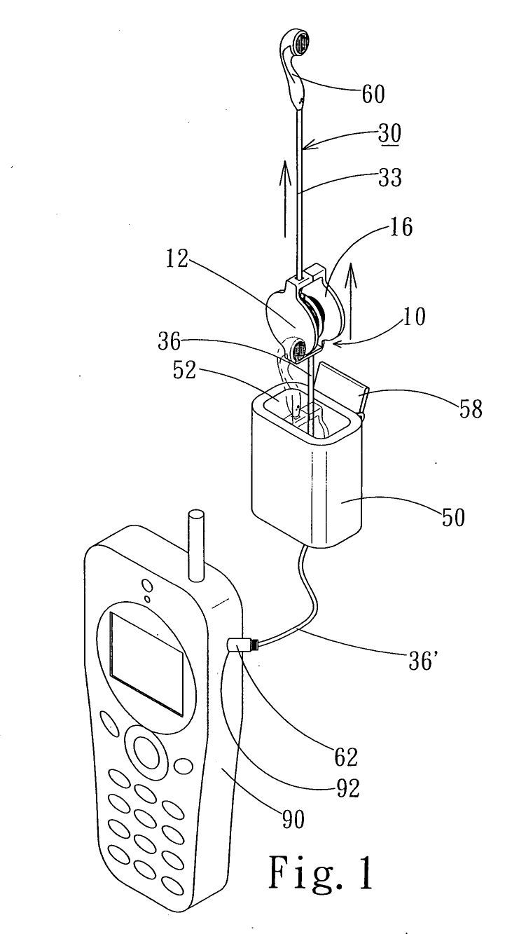

FIG. 2 shows a sectional view illustrating the invention implemented to a cellular phone and with a wire released.

FIG. 3 is a partial enlarged view of FIG. 2 illustrating the fastening member.

FIG. 4 a sectional view illustrating the invention implemented to a cellular phone and with a wire collected and stored.

FIG. 5 shows a sectional view illustrating the invention implemented between two electric appliances and with a wire collected and stored.

FIG. 6 shows a sectional view illustrating the invention implemented between two electric appliances and with a wire released.

FIG. 7 shows an elevational view illustrating the invention connected to an accommodating rope.

FIG. 8 shows a motional sectional view illustrating the invention implemented to a mouse.

FIG. 9 shows a motional sectional view illustrating the invention implemented to a battery charger.

### DETAILED DESCRIPTION OF THE PREFERRED EMBODIMENTS

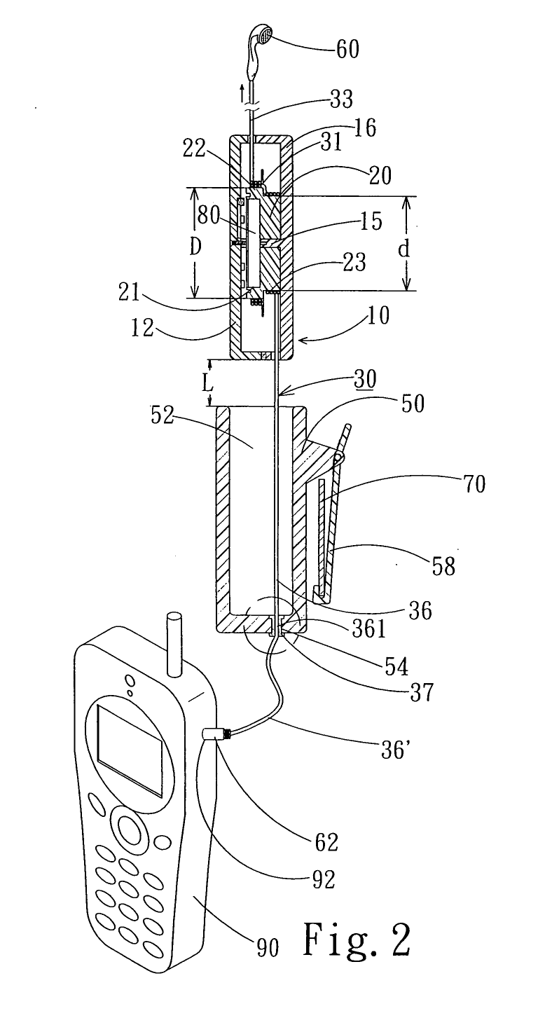

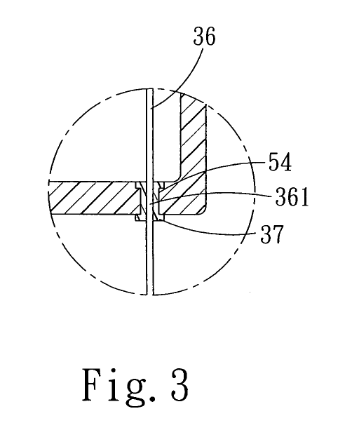

Referring to FIGS. 2 and 3 showing a wire in a released status, the main wheel 20 has the outer diameter D of the A wire storage breadth 22 larger than the outer diameter d of the B wire storage breadth 23 (D>d), and is clasped to clothing 70 such as a belt using the clamp 58, with the terminal plug (socket) 62 inserted and connected to a signal output terminal 92 of a cellular phone 90. When receiving incoming calls, the upper wire 33 is pulled out by tugging the earphone microphone 60. The main wheel 20 is rotated relative to the axis portion 15 as a rotation center thereof, the spring 80 is tensioned and stretched, and the A and B wire storage breadths 22 and 23 are coaxially and simultaneously rotated. Thus, a released length of the upper wire 33 is much longer than that of the lower wire 36 owing to D>d.

During a release process of the upper and lower wires 33 and 36, the entire wire storage structure 10 comprising the left and right housing 12 an 16 is departed from the accommodating chamber 52 to move outward in a upward direction, with a departed distance L being directly proportional to a ratio of the two outer diameters D and d (D:d). When D:d is 1:1, lengths of the upper and lower wires 33 and 36 released are equal, and the distance L has a greatest value.

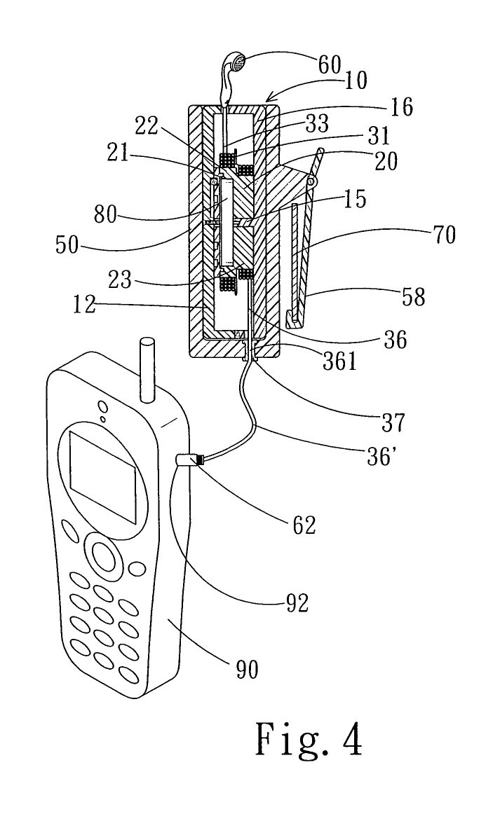

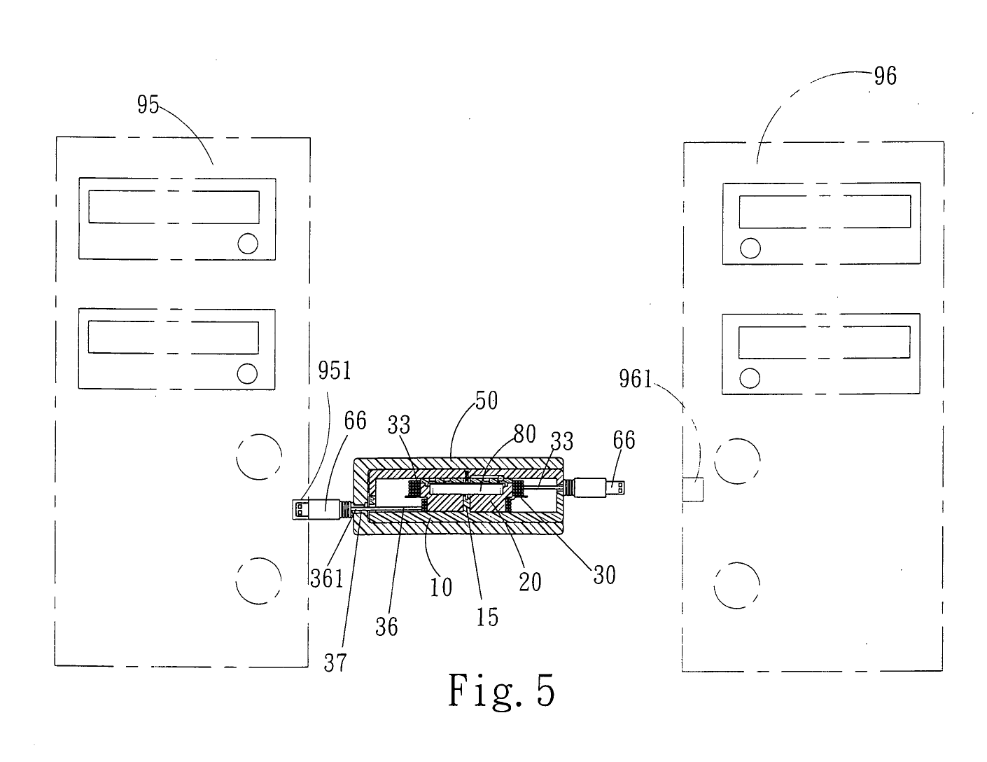

When the outer diameter D is larger than the other outer diameter d, and especially when the main wheel 20 is rotated in a same direction, a released length of the upper wire 33 is longer than that of the lower wire 36, and the distance L of the entire wire storage structure 10 displaced out of the storage chamber 52 is much less than that when D:d=1:1. Hence, when the entire wire storage structure 10 is stored in the accommodating chamber 52 as shown in FIGS. 4 and 5, a main body of the wire storage structure 10 is not inappropriately picked, and only the earphone microphone 60 is pulled upwards by a user's fingers. Consequently, possibility of the upper wire 33 being displaced upward is eliminated, and chances of the upper wire 33 arranged in disorder and congestion in the A wire storage breadth 22 are reduced.

Referring to FIGS. 4 and 5 illustrating wires collected and stored, when pulling forces upon the earphone microphone 60 are dismissed, the spring 80 is elastically restored, the main wheel 20 is rotated in a reverse direction, and the upper and lower wires 33 and the lower wire 36 are respectively winded back in opposite directions into the A and B wire storage breadths 22 and 23. The main body of the wire storage structure 10 is completely placed into the accommodating chamber 52 when the wires are collected, thereby storing the wire storage structure 10 into the accommodating chamber 52 when not in use. Thus, the wire storage structure 10 is prevented from exposures to the clothing 70, and is also protected by the seat 50 to be kept away from damages caused by external forces.

Referring to FIGS. 2-4 showing another embodiment according to the invention, a fastening member 37 is utilized to fasten at a suitable section of the lower wire 36 and in the opening 54, such that the lower wire 36 is formed with a fixed end 361. Thus, a length of the lower wire 36′ exposed below the seat 50 stays constant, and the terminal plug (socket) 62 is inserted to the signal output terminal (opening) 92 for serving signal transmissions of the cellular phone 90.

In addition, the fixed section 31 is for distinguishing the upper and lower wires 33 and 36 at a same signal line 30, and is a wedging and fastening point when the upper and lower wires 33 and 36 are pulled to extremities thereof.

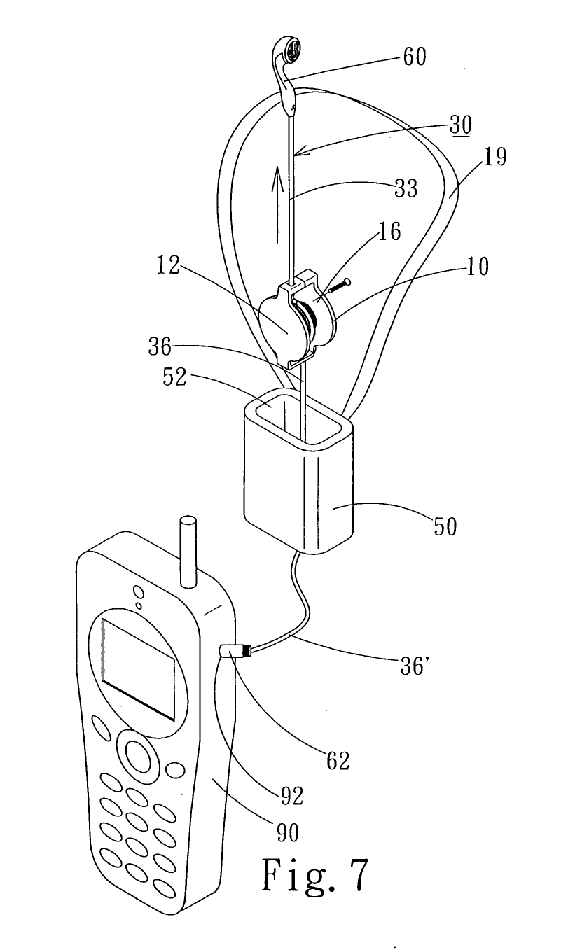

Referring to FIG. 7, the invention can be placed around a user's neck using an accommodating rope 19 to have the seat 50 suspended at front of the user's chest and to facilitate access of the earphone microphone 60 using the user's hand.

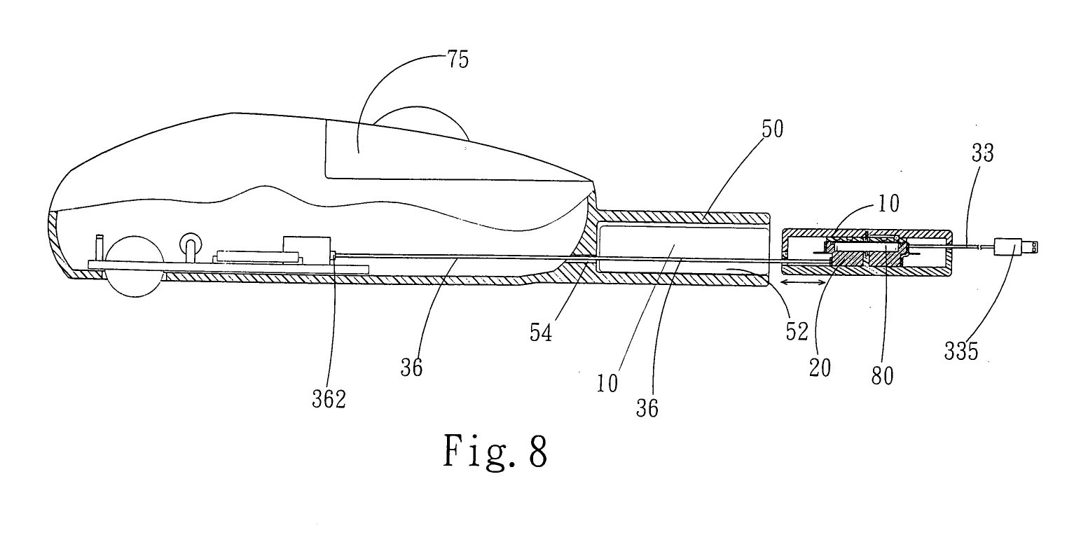

Referring to FIG. 8, the seat 50 according to the invention is directly devised at an exit of the mouse 75, and the fixed end 362 of the lower wire 36 is fastened to a hardware structure at the interior of the mouse 75. When the plug 335 is pulled out, the upper and lower wires 33 and 36 are respectively released, and the wire storage structure 10 is displaced out of the accommodating chamber 52 to be ready to put to application. When pulling forces upon the plug 335 are dismissed, the upper and lower wires 33 and 36 are winded back into the A and B wire storage breadths 22 and 23 of the wire storage structure 10, and the wire storage structure 10 is reversely displaced back into the accommodating chamber 52 for protection. Therefore, when the plug 335 is withdrawn, the main body of the wire storage structure 10 is prevented from inappropriate tugging of a user's hand.

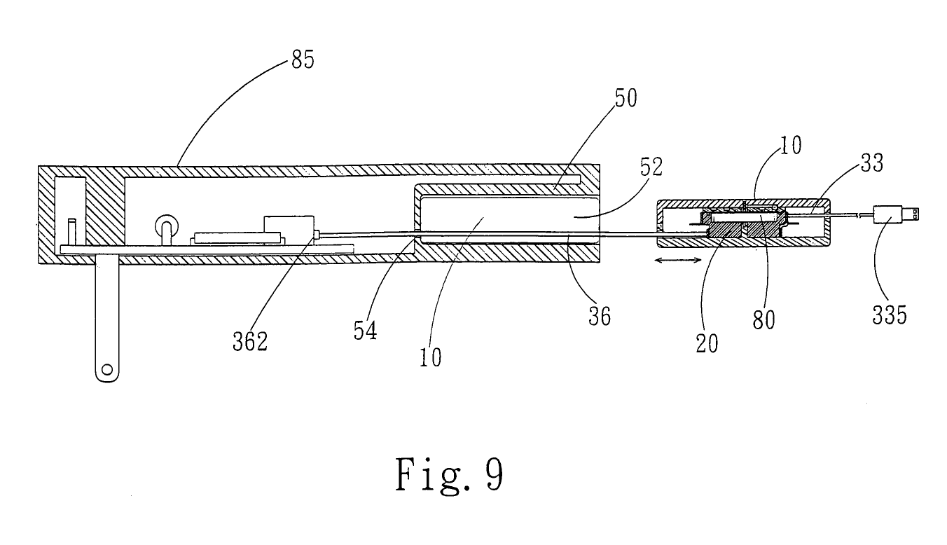

Referring to FIG. 9, the seat 50 according to the invention is directly devised a an interior or at an outer periphery of a battery charger 85, and the fixed end 362 of the lower wire 36 is connected to a hardware structure at the interior of the battery charger 85. When the plug 335 is pulled out, the upper and lower wires 33 and 36 are respectively released, and the wire storage structure 10 is displaced out of the accommodating chamber 52 to be ready to put to application. Similarly, when pulling forces upon the plug 335 are dismissed, the upper and lower wires 33 and 36 are restored, and the wire storage structure 10 is reversely displaced back into the accommodating chamber 52 for protection. Therefore, when the plug 335 is withdrawn, the main body of the wire storage structure 10 is prevented from inappropriate tugging of a user's hand.

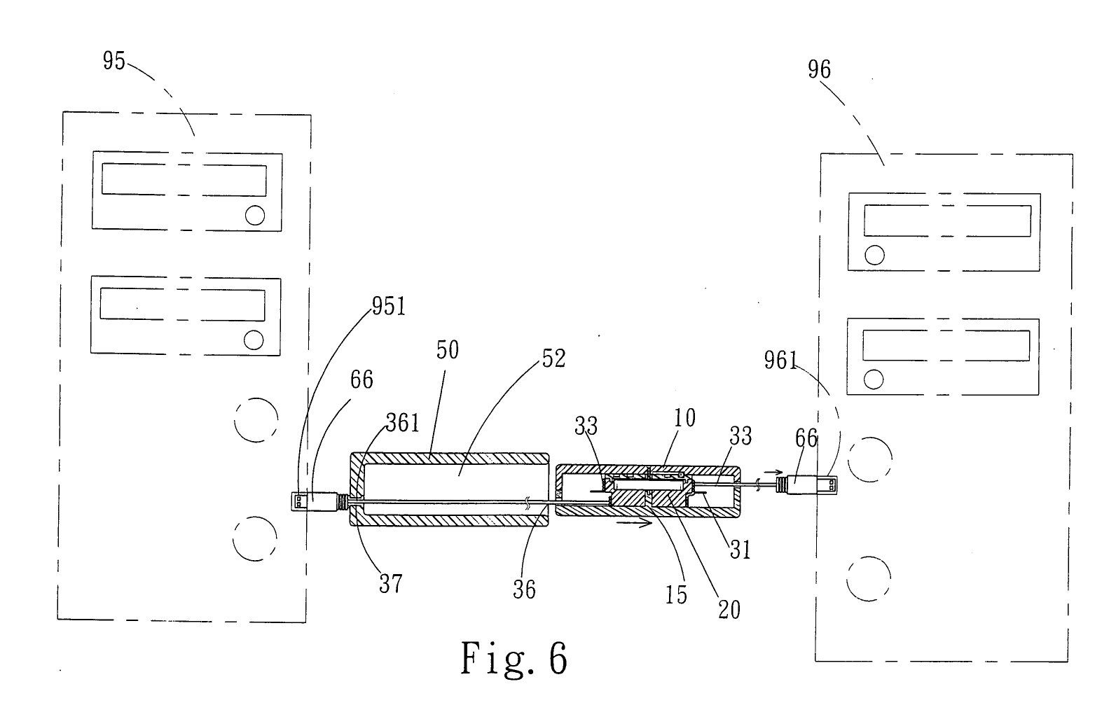

Referring to FIGS. 5 and 6, outer ends of the upper and lower wires 33 and 36 of wire storage structure 10 according to the invention are respectively connected to USB connectors 66. The lower wire 36 is provided with a fixed end 361, and hence one of the USB connectors 66 is inserted to a signal connecting port 951 of an electric appliance 95. When the USB connector 66 connected to the upper wire 33 is pulled out and inserted to a signal connecting port 961 of another electric appliance 96, the upper and lower wires 33 and 36 are respectively released with a certain length, and the wire storage structure 10 is displaced out of the accommodating chamber 52. Referring to FIGS. 5 and 6, when pulling forces upon the upper wire 33 are dismissed, the upper and lower wires 33 and 36 are restored and winded back into the main body 20, and the wire storage structure 10 is reversely displaced back into the accommodating chamber 52 for protection. Therefore, the main body of the wire storage structure 10 is prevented from inappropriate tugging of a user's hand.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A device for accommodating a wire storage structure, comprising:
a wire storage device consisted of left and right housing, a main wheel and an axis portion;
a main wheel capable of elastic rotations relative to the axis portion as a center of rotation thereof, and having at least two A and B wire storage breadths;
a continuous signal wire having a fixed section wedged and fastened at an appropriate position between the A and B wire storage breadths, and winded around the A and B wire storage breadths in opposite directions to define upper and lower wires; and
a seat having an accommodating chamber, which is provided with an opening for inserting through the lower wire, with the wire storage structure displaced into the accommodating chamber and positioned therein when the upper and lower wires are collected and stored at the A and B wheel breadths.

2. The device for accommodating a wire storage structure in accordance with claim 1, wherein an outer diameter of the A wire storage breadth is larger than an outer diameter of the B wire storage breadth.

3. The device for accommodating a wire storage structure in accordance with claim 1, wherein an outer diameter of the A wire storage breadth is equal to an outer diameter of the B wire storage breadth.

4. The device for accommodating a wire storage structure in accordance with claim 1, wherein an outer diameter of the A wire storage breadth is smaller than an outer diameter of the B wire storage breadth.

5. The device for accommodating a wire storage structure in accordance with claim 1, wherein the seat is directly devised at an exit of a mouse, a fixed end of the lower wire is electrically connected to an internal structure of the mouse in a direct manner, and an outer end of the upper wire is connected to a plug/socket, thereby storing the wire storage structure into the accommodating chamber.

6. The device for accommodating a wire storage structure in accordance with claim 1, wherein the seat is directly devised at an interior of a battery charger to have an opening of the accommodating chamber locate at an end portion of the battery charger, a fixed end of the lower wire is electrically connected to an internal structure of the mouse in a direct manner, and an outer end of the upper wire is connected to a plug/socket, thereby storing the wire storage structure into the accommodating chamber.

7. The device for accommodating a wire storage structure in accordance with claim 1, wherein the lower wire has a suitable section thereof fastened in the opening using a fastening member to form a fixed end at the lower wire.

8. The device for accommodating a wire storage structure in accordance with claim 1, wherein a rear wall of the seat is provided with an elastic clamp for clamping to clothing.

9. The device for accommodating a wire storage structure in accordance with claim 1, wherein the outer end of the upper wire is connected to an earphone microphone/earphone, and an outer end of the lower wire is connected to a terminal plug/socket.

10. The device for accommodating a wire storage structure in accordance with claim 1, wherein the outer ends of the upper and lower wires are respectively connected to Universal Serial Bus (USB) connectors.

11. The device for accommodating a wire storage structure in accordance with claim 1, wherein a side groove at an interior of the main wheel is connected to a spring, which has an inner end thereof joined and fixed to the axis portion to allow the main wheel to be formed as an elastic element.

12. The device for accommodating a wire storage structure in accordance with claim 1, wherein a side of the seat is connected to an accommodating rope to be placed around a user's neck.
